(19) United States
(12) Patent Application Publication
(10) Pub. No.: US 2006/0080166 A1
(43) Pub. Date: Apr. 13, 2006

(54) ADVERTISING BOX AND ITS USE IN AN ONLINE ADVERTISING SYSTEM

(76) Inventor: Aiichiro Takahashi, Forest Hills, NY (US)

Correspondence Address: ShenLaw Firm, 36-40 Main St., Suite 306, Flushing, NY, 11354, US

(21) Appl. No.: 10/711,891

(22) Filed: Oct. 12, 2004

(51) Int. Cl. G06Q 30/00

(52) U.S. Cl. 705/14

(57) ABSTRACT

This innovation provides an online advertising method and an online advertising system, in which advertisers can easily update their ad contents while ad viewers can easily personalize ad selection and sort out information they are truly interested in.

### BACKGROUND

1. Field of the Invention

The present invention relates generally to online advertising systems, and more particularly, to systems, which enable advertisers to control the design and to update online advertising contents and enable viewers to control the display of selected online advertising contents.

2. Discussion of the Related Art

In this application, we refer a person who intends to release information to general public as an advertiser, the information released as advertisement (or ad in abbreviation) and a person to whom the ad is released as an advertisement viewer (or ad viewer in abbreviation).

As growing more and more popular, Internet becomes one of the major advertisement channels, especially for small businesses and individuals. Compare to traditional media, such as TV, newspapers and magazines, online advertising offers some great advantages—broader ad viewers, no limitation of covering area and cheaper. As a result, many traditional media started to offer their subscriber an alternative online version of their hard-copy advertisement.

However, before going campaign online, advertisers have to work out many obstacles. First of all, “how to do it?” is the question they have to answer. Too many choices often leave advertisers in confusion, especially small companies and individuals. Should they build their own campaign web pages or should they advertise on other web sites? If advertising on other web sites, which ones to choose? It often depends on the nature of the ads, spending expectation, personal preferences, popularity of the web sites, etc. Secondly, advertisers have to decide the contents in their ads. Thirdly, advertisers have to decide how often they are going to update and how to update information in their ads.

Ad viewers also face similar problems. Numerous ads on the Internet cause people immune to online advertisement. The reasons are addressed as following. First, too many pop-ups and banners spread on the Internet, which significantly slow down surfing speed and make online ads notorious. Actually they are so annoying that people even buy software to stop them on purposes. Second, there are too many online advertising resources, which could puzzle even a veteran net surfer. It is often hard to decide where the best source is for certain advertising information. Third, too much out-of-date information left online, which not only wastes people's time, bandwidth and storage space but also results in outcomes from many searching engines being still a labyrinth. Fourth, only limited information is available in ads. For example, many local web pages provide information about local stores. It is often a case that only store names, addresses and telephone numbers are available, which make those ads far less attractive. If there are some ongoing events about these stores listed in their ads, will it be more useful and attractive to ad viewers? The answer is positive. However, web hosts currently have no resource and advertisers have no power to keep such information updated.

Advertisers lack powers to control when and how to update their advertising information. The traditional online advertisement system requires advertisers to submit their advertising requests to a web host. The web host will organize these requests into an html file and publish them on the Internet. In order to update the contents, the advertisers often have to prepare and ftp new ad materials to the web host or ask the web host to make any kind changes they desire to have. When the advertisers create their own files, an html generating software, such as Dreamweaver, is most likely required, which limits the ability of advertisers to update information. Once the updating process is complete, the web host will release the updated ads to the Internet. Since a third party, the web host, is involved, it is unavoidable that the updating of the contents will be delayed.

To increase the advertising efficiency, the needs of ad viewers have to be considered. Over-advertising can only have negative impact on ad viewers. To some extends, newspaper is a quite efficient way for advertising purpose. The ads in newspapers are local related and are also categorized so that viewers are able to quickly find their interested sections. In addition, people are able to browse a lot and compare different ads simultaneously.

In the U.S. Pat. Application No. 20020103698 to Cantrell, an advertising system and method, which enables user to control the creation and deployment of banner ad campaigns, is disclosed. Since it is mainly focused on banner advertisement and it neglects the importance of ad viewer's preferences, the system is significantly limited on the improvement of ad efficiency.

How to improve the efficiency of online advertisement challenges every online advertiser. Keeping information up to date and giving ad viewers what they want will not only make the ad information more useful but also retain the viewers longer. This innovation provides an online advertising method and system, which is easier for advertisers to update their ad contents and is also customizable for ad viewers to sort out the information they are truly interested in. In another word, the server takes a neutral position between advertisers and ad viewers, since advertisers have the power to decide what and when they want to advertise and ad viewers have the power to decide what they want to be advertised. As a result, both advertisers and ad viewers will feel comfortable about what they do. It is a perfect system for “point-to-point” marketing.

### SUMMARY OF THE INVENTION

The present invention provides an advertising method using an advertising box, in which an advertiser is able to enter advertising information and design the appearance of the advertising information. The advertising information will be presented to ad viewers in an advertising box with the same appearance designed by the advertiser.

The present invention further provides an online editing tool so that advertisers can use advertising boxes to create and update advertising information with any web browsers.

In addition, the present invention provides an advertising system through which ad viewers can control what they want to be advertised based on their preference. The registered ad viewers can select some ads and save them into “My Favorite Page”. Moreover, a RSS feed system is provided to consistently update advertising information with registered ad viewers, who can selectively subscribe to RSS channels containing ads that they are interested in.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 illustrates an advertising network.

FIG. 2 illustrates the main page with six advertising boxes shown.

FIG. 3 illustrates the registration page for ad viewers.

FIG. 4 illustrates the login page for ad viewers.

FIG. 5 illustrates “My Favorite Page” for ad viewers.

FIG. 6 illustrates the login page for advertisers.

FIG. 7 illustrates editorial page.

FIG. 8 illustrates the templates for editorial page.

FIG. 9 illustrates the preview page for advertisers.

FIG. 10 illustrates the RSS feeding in advertising boxes.

FIG. 11 illustrates how to use a RSS reader to receive news from selective ads.

### DETAILED DESCRIPTION

In this invention, we refer an “advertising box” as an area where an advertiser is able to enter advertising information and design the appearance of the advertising information. The advertising information includes the advertising contents and general information about the advertiser. The advertising contents could include but not be limited to ad objective, text, image, flash, movie clip and html link. The appearance of the advertising information is the information regarding the position of the advertising contents within an advertising box.

In general, the creation of an ad contains the following processes. After receiving a request from an advertiser computer, the server will transmit a program to the advertiser computer and enable the computer to display an advertising box. Using editing tools, the advertiser can create or update advertising information within the advertising box. Once the submit button hit, the program will transmit both the advertising information and the appearance of the advertising information to the server. This submitted information would be saved in a database on the server.

To respond to an ad viewer request, the server will generate a list of ads that contain advertising information matching the viewer's criterions. For each ad in the list, the server will send both the advertising information and the appearance of the advertising information to the viewer's computer as well as a program, which will enable the computer to display an advertising box and utilize the appearance of the advertising information to deploy the advertising information within the advertising box.

Many programming languages could be used to code the program mentioned above. The program should include the following steps—enables a computer to display an advertising box, submits information from advertisers to the server and utilizes the information transmitted from the server to an ad viewer computer to deploy the advertising information according to the appearance information of the advertising information on the viewer computer. Each individual step is well known to a person skilled in the relevant art. Although Java, JavaScript and ActiveX are preferred since a program written with these languages can be executed independently of operating systems.

The tool, which enables an advertiser to create or update advertising information within an advertising box, can also be written with many programming languages, although Java, JavaScript and ActiveX are preferred. The way to code such tool is well known to a person skilled in the relevant art.

In the preferred embodiment, the advertising information and the appearance of the advertising information are packed into an encrypted package when transmitted between an advertiser and a server or between a server and an ad viewer.

Many kinds of database can be used to store advertising information and the appearance of the advertising information, although a SQL database, such as Oracle or MySQL, is preferred.

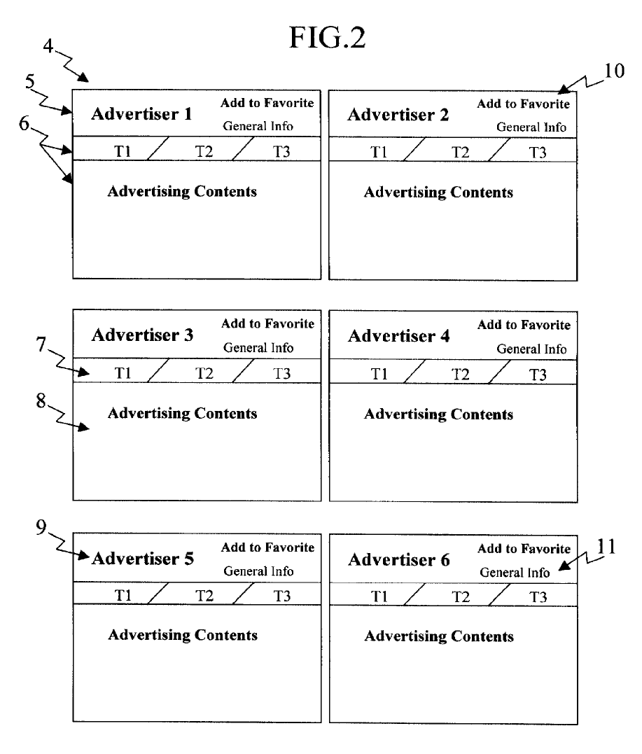

On an html-coded page, an advertising box defines an area where an advertiser places advertising information. The shape and the size of an advertising box are not essential, although rectangle shape is preferred as seen in FIG. 2. The visibility, color and width of the outside borders surrounding an advertising box are also not important, although a visible thin line around an advertising box is preferred as seen in FIG. 2.

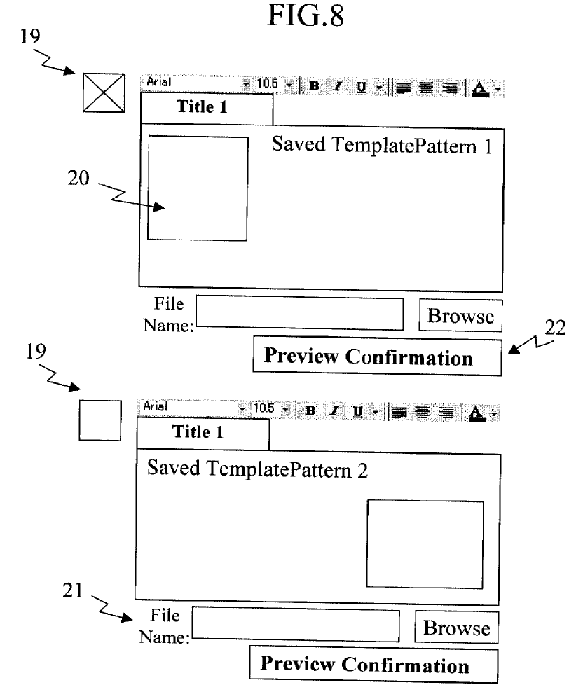

An advertiser defines advertising information within an advertising box. The advertising box can either be used as a single region or be further divided into several regions called panels. Where multiple panels are defined, each panel can be assigned for different purposes as seen in FIG. 2. Contents such as ad objective, texts, pictures, flash, movie clips, RSS feeding as well as web links can all be placed in an advertising box. The dimensions of an advertising box could be either limited to certain size or no limitation at all. In the preferred embodiment, the width of all advertising boxes is same so that every row in a web page is able to harbor two advertising boxes comfortably as seen in FIG. 2. The length of an advertising box is unlimited or determined by the template it is using, as seen in FIG. 8.

A preferred embodiment of the invention is discussed in detail below. While specific implementations are discussed, it should be understood that this is done for illustration purposes only. A person skilled in the relevant art will recognize that other components and configurations may be used without parting from the spirit and scope of the invention.

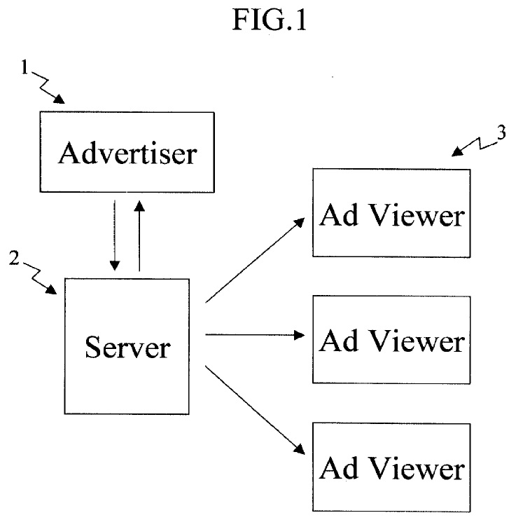

Referring to FIG. 1, an advertiser sends a request from his computer 1 to a server 2 using ajavaScript-enabled web browser. The server 2 renders information to display an advertising box with an online editing tool on the interface of the advertiser computer 1. Using the online editing tool, the advertiser can create or update advertising information within the advertising box. Once finished, the advertiser submits the updated advertising information and the appearance information of the updated advertising information to the server 2. And then the server 2 will transmit the updated information to ad viewer computers 3 and enable the ad viewer computers 3 to display the updated advertising information in the appearance designed by the advertiser.

Referring to FIG. 2, in the preferred embodiment, multiple advertising boxes 4 are present on every page displayed on an ad viewer computer. Each page contains ads related to same objective. The order of the advertising boxes shown on every page could be fixed, randomized or based on some rules, such as popularity, ad fee rate, etc.

In the preferred embodiment, each advertising box 4 is further divided into an upper panel 5 and a lower panel 6. In the upper panel 5, there are the advertiser's name 9 and general information 11, such as telephone number, address, home page link, etc. In addition, there is a small button at the up right corner named “Add to Favorite” 10. The lower panel 6 contains advertising contents. In the preferred embodiment, the lower panel 6 contains a tab panel 7 harboring multiple tabs, each of which, once clicked, directs different advertising contents displayed in the content panel 8.

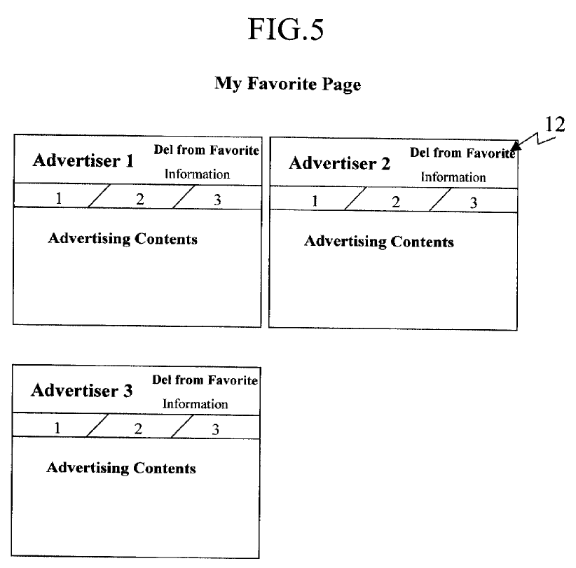

In the preferred embodiment, the “Add to Favorite” 10 is inactive for general ad viewers and will be available for registered ad viewers, which will be described in FIG. 5.

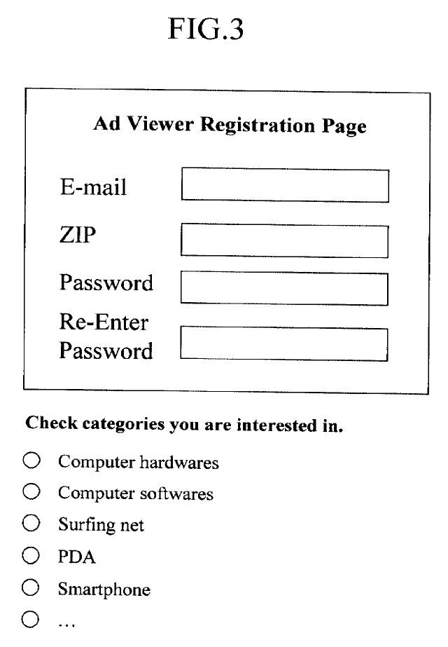

Referring to FIG. 3, in order to be better served, an ad viewer should register with the server 2. During registration process, the ad viewer has an option to set up his/her preference, such as living area, hobby, favorite food, etc. In the preferred embodiment, this information will be stored in a database on the server 2. As a result, the ad viewer is able to utilize his/her own preference settings with a web browser on any computer. Alternatively, cookies could be utilized to store the preference of an ad viewer in the situation where the ad viewer computer is not shared among different people.

Cookies are small pieces of information stored on individual's browsers that can later be read back from the browser. When a web site is accessed, a cookie may be sent by the web site identifying itself to the web browser. Cookies are stored by the browser and may be read back by a server at a later date. Cookies may be utilized for a variety of reasons including the ability to personalize information, to perform targeted advertising, or to track popular links or demographics. Cookies can store a variety of information including database information and custom page settings.

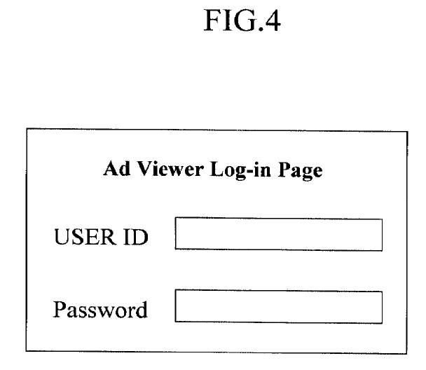

Referring to FIG. 4, registered ad viewers have to log into their accounts to benefit from their preference settings. In the situation where the ad viewer computer is not shared among different people, a cookie can also be used to facilitate the login process for a registered ad viewer.

Referring to FIG. 5, My Favorite Page

After a registered viewer logs into the server 2, only ads matching to the ad viewer preferences will be displayed. A registered viewer can also click on the “Add to Favorite” button 10 in an advertising box to add the ad to “My Favorite Page” so that he/she has a collection of his/her most favorite advertisers. Once added to “My Favorite Page”, the “Add to Favorite” button 10 in the advertising box is changed to “Del From Favorite” button 12, which will remove the ad from “My Favorite Page” if clicked.

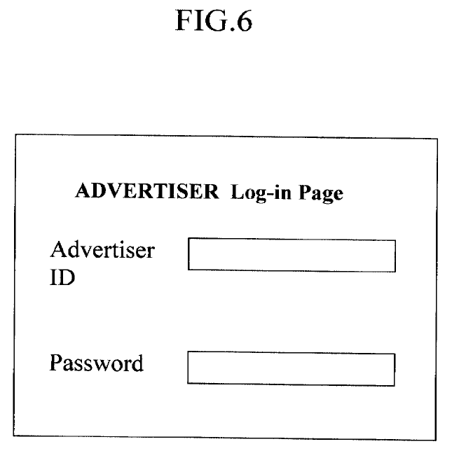

Referring to FIG. 6, advertisers have to log into their accounts to create or update their ads. In the preferred embodiment, the login information of an advertiser is stored in a database on the server 2. As a result, the advertiser is able to access his/her own ads with a web browser on any computer any time. In the situation where the advertiser computer is not shared among different people, a cookie can also be used to facilitate the login process for an advertiser.

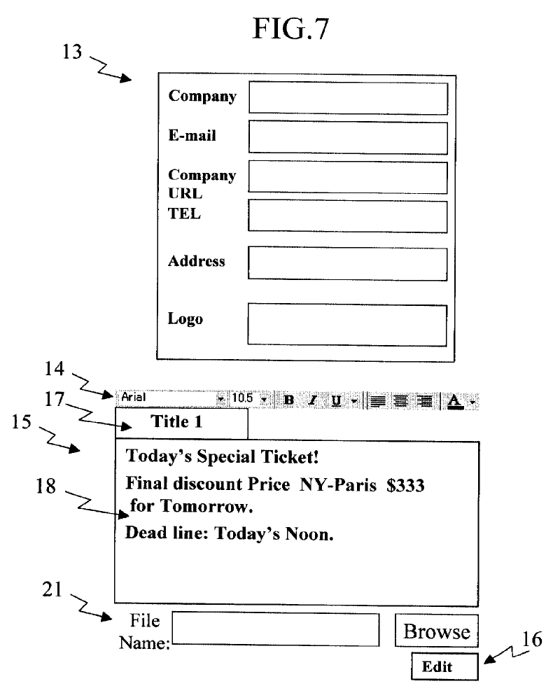

Referring to FIG. 7, the editing page for an advertising box includes an information editing form 13 and advertising content editing boxes 15.

Information editing form 13 is used to add or modify information in the upper panel 5 of an advertising box 4. In the preferred embodiment, the form 13 includes items such as advertiser name, logo, telephone number, email, company URL as well as company address. Not all of the items are required.

In the preferred embodiment, every tab 7 corresponds to a different advertising-content editing box 15 in the editing page of an advertising box 4. Each advertising-content editing box 15 is associated with an online editing tool 14. Once click on “Edit” button 16, the tab title 17 and the content 18 become editable. Using the online editing tool 14, the advertiser is able to add or modify any text contents and change the format of those text contents as well. The format includes fonts, size, colors, styles as well as other formatting.

The online editing tool 14 can be written using many different programming languages, although JavaScript, Java or ActiveX are preferred, since an editing tool 14, which is written with JavaScript, Java or ActiveX, can be executed independently of operating system platforms.

Referring to FIG. 8, advertisers have many choices in templates for an advertising box. A template is a predefined set-up, which is used as a starting point to define a general appearance or pattern of an advertising box. When designing an ad, the advertiser can choose a template to work with as a start point, and then add or modify any texts, pictures, flash, movie clip, etc. to the ad. To pick up a template, the advertiser needs to mark the checkbox 19 in front of the template.

For a template that has multimedia boxes 20 inside an advertising box, files have to be uploaded for the multimedia boxes. A multimedia box, dependent on its type, is able to harbor an image, a movie clip, a flash or others. To upload a file, an advertiser has to use file selecting bar 21 to browse and select a file from his/her own computer. The selected file will be uploaded to the server 2.

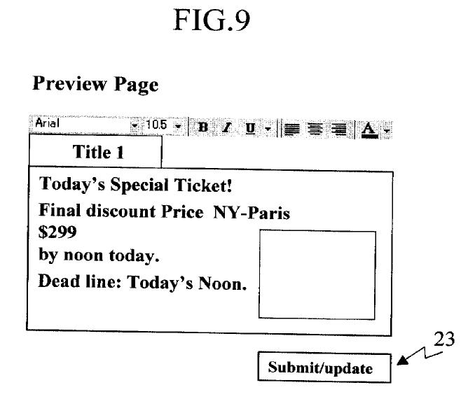

Referring to FIG. 9, after created a new ad or updated contents of an ad, the advertiser can clicks on “Preview” button 22 to make a judgment about the ad. If satisfied, the advertiser hit on “Submit” button 23 to submit the ad to the server 2. The server 2 will immediately deliver the updated information to ad viewers.

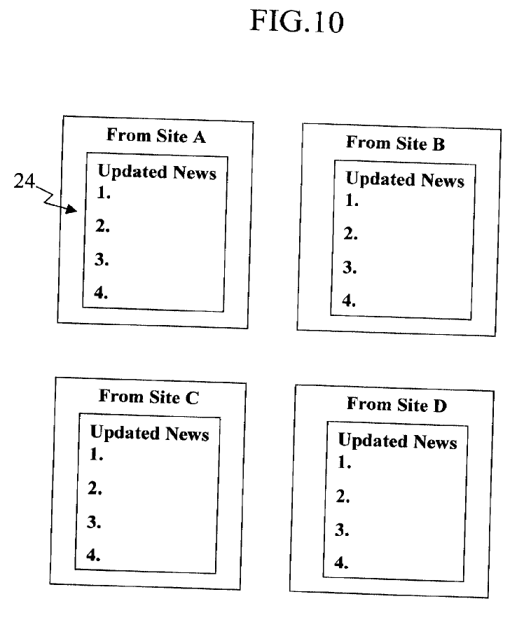

Referring to FIG. 10, an advertising box can contain RSS feeds 24 so that a registered ad viewer is able to read RSS from different site on one web page.

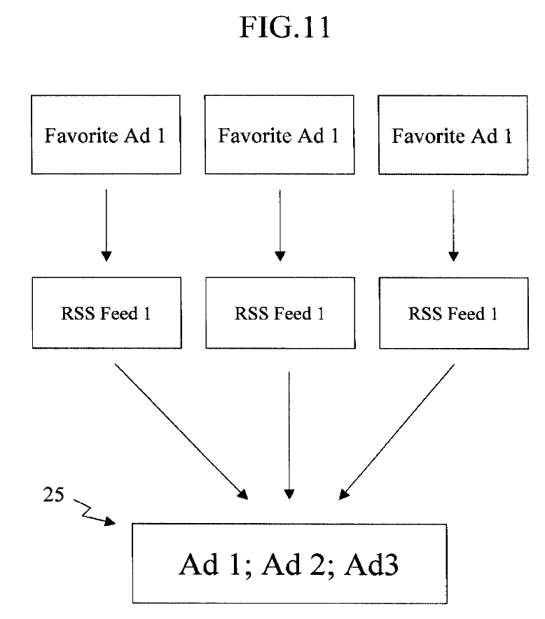

Referring to FIG. 11, registered ad viewers can use a RSS reader to receive updated information from their favorite ads. RSS feed is created for every advertisement on the server 2. When a registered ad viewer selects ads for “My Favorite Page”, he/she also subscribes to corresponding ad channels. Using any RSS reader 25, the registered ad viewer can direct those channels to the RSS reader and receive latest news about those ads that he/she is most interested in.

RDF Site Summary (RSS) is a lightweight multipurpose extensible metadata description and syndication format. RSS is an XML application, conforms to the W3C's RDF specification and is extensible via XML—namespace and/or RDF based modularization.

One creates a file that meets an RSS standard, (the file is known as an RSS feed), and save the file on your website. Other people link to that file, and display the contents on their website. If one update the RSS feed file on your site, changes are picked up straight away by everyone who links to it.

Some non-limiting examples illustrative of practical commercial and industrial applications of the invention will now be described.

### EXAMPLE 1

A Community News System

A community news announcer, who acts as the advertiser, is able to log into the server by accessing anyjavaScript-enabled web browser at any time. After login, he can add or update any news. The news is immediately shown up on the web page as well as on RSS feed system. Any viewer can read the news by using a web browser or a RSS reader. In this example, it might not be necessary for viewers to register with the server. Therefore, neither personalizing nor “My Favorite Page” is needed.

Similar situation is also applied to an individual Restaurant Menu system, where Today's Menu, lunch, Dinner or special can be updated easily; to a Public Transportation News system; to a Community Emergency System; to name a few.

### EXAMPLE 2

A School Schedule System

A system like this is very useful for students since they are able to manage their schedules directly from home or any place where internet-access computers are available. In this case, a school official, who acts as the advertiser, is able to log into the server by accessing anyjavaScript-enabled web browser at any time. After login, he can add or update any school schedules. The updated schedules are immediately shown up on the web page as well as on RSS feed system. Students, who act as the ad viewers, are able to view the schedules by using a web browser or a RSS reader. In addition, students might register with the server. When a registered student logs into the server, a browser or a RSS reader will display only schedules he/she is interested in.

### EXAMPLE 3

A Local Restaurant Advertising System

In this situation, there are multiple advertisers displaying their own ads against to each other. Every advertiser is able to log into the server by accessing anyJavascript-enabled web browser at any time. After login, he can add or update any ads, such as Today's Specials. The updated ads are immediately shown up on the web page as well as on RSS feed system. Restaurant customers, who act as the ad viewers, are able to view ads from different restaurants by using a web browser or a RSS reader. In addition, customers might register with the server. When a registered customer logs into the server, a browser or a RSS reader will display only ads from local restaurants he/she is interested in.

### EXAMPLE 4

An Airline Tickets Sale System

In this situation, there are multiple advertisers displaying their own ads against to each other. Every advertiser is able to log into the server by accessing anyJavaScript-enabled web browser at any time. After login, he can add or update ticket information at any time, such as ticket price, etc. The updated ads are immediately shown up on the web page as well as on RSS feed system. Airline tickets buyers, who act as the ad viewers, are able to view ads from different airlines and access lately price information by using a web browser or a RSS reader. In addition, buyers might register with the server. When a registered buyer logs into the server, a browser or a RSS reader will display only ads from Airlines he/she is interested in or information about those trips he/she is interested in.

### EXAMPLE 5

A Real Estate Sale System

In this situation, there are multiple advertisers displaying their own ads against to each other. Every real estate agent is able to log into the server by accessing anyjavaScript-enabled web browser at any time. After login, he can add or update any ads, such as latest prices. The updated ads are immediately shown up on the web page as well as on RSS feed system. Real estate buyers, who act as the ad viewers, are able to view ads from different real estate agents and access latest price information by using a web browser or a RSS reader. In addition, buyers might register with the server. When a registered buyer logs into the server, a browser or a RSS reader will display only ads from areas he/she is interested in.

### EXAMPLE 6

A Local Business Advertising System

In this situation, there are multiple advertisers displaying their own ads against to each other. These advertisers engage in different types of business. For instance, some are restaurants, some are drug stores, some are cloth stores, etc. Every advertiser is able to log into the server by accessing any JavaScript-enabled web browser at any time. After login, he can add or update any news, such as Today's Specials, Discount information, Super Sales, etc. The updated news is immediately shown up on the web page as well as on RSS feed system. Local customers, who act as the ad viewers, are able to view ads from different advertisers by using a web browser or a RSS reader. The customers may also view the ads be different categories. In addition, customers might register with the server. When a registered customer logs into the server, a browser or a RSS reader will display only ads from the types of business he/she is interested in. A registered customer can also add any advertiser to “My Favorite Page”. As a result, “My Favorite Page” will collect all advertisers he/she wants to pay attention to.

Similar situation is also applied to a job Opening system, a Catalog Site system, a Coupon system, a Company Internal Communication system, an Events Announcement system or other general Promotion Campaigns.

Although this invention has been described in certain specific embodiments, many additional modifications and variations would be apparent to those skilled in the art. It is therefore to be understood that this invention may be practiced otherwise than is specifically described. Thus, the present embodiments of the invention should be considered in all respects as illustrative and not restricted, the scope of the invention to be indicated by the appended claims rather than the foregoing description.

What is claimed is:

1. An online advertising method, comprising:
(a) receiving first information from an advertiser, said first information being used to request an advertising box, wherein said advertising box is an area where said advertiser is able to enter advertising information and design the appearance of said advertising information;
(b) transmitting second information to said advertiser, said second information enabling said advertiser computer to display first advertising box;
(c) receiving third information from said advertiser, said third information being used to define advertising information and the appearance of said advertising information within said first advertising box;
(d) transmitting fourth information to an ad viewer computer, said fourth information enabling said ad viewer computer to display second advertising box and utilize said appearance of said advertising information to deploy said advertising information within said second advertising box.

2. The online advertising method of claim 1, wherein said second information further comprises an editing tool to enable said advertiser to modify advertising information within said first advertising box.

3. The online advertising method of claim 2, wherein said modify includes changing advertising contents within said first advertising box.

4. The online advertising method of claim 2, wherein said modify includes changing advertising objective within said first advertising box.

5. The online advertising method of claim 2, wherein said modify includes changing localization of advertising contents within said first advertising box.

6. The online advertising method of claim 2, wherein said modify includes identifying one or more templates that are associated with said first advertising box.

7. The online advertising method of claim 2, wherein said editing tool is executed independently of operating system platforms.

8. The online advertising method of claim 7, wherein said operating system platforms include a computer device (IBM-PC, Apple Macintosh, Tablet PC, etc.), a hand-held device (PDA, Palm, etc.), a phone device, or other devices running an HTML-capable viewer.

9. The online advertising method of claim 8, wherein said HTML-capable viewer includes Internet Explorer, Netscape, Opera and other web browsers, which are JavaScript-enabled.

10. The online advertising method of claim 7, wherein said editing tool is written in JavaScript.

11. The online advertising method of claim 1, wherein said advertising information includes advertising objective, texts, pictures, movie clips, flash and html links.

12. The online advertising method of claim 2, wherein said advertising information includes advertising objective, texts, pictures, movie clips, flash and html links.

13. An online advertising system, comprising: a processing system that
(a) receives a request from an advertiser for an advertising box, wherein said advertising box is an area where said advertiser is able to enter advertising information and design the appearance of said advertising information;
(b) enables said advertiser computer to display first advertising box;
(c) optionally, selects an existing advertising information associated with said advertiser if any available; renders said existing advertising information and the appearance of said existing advertising information if any available to said advertiser computer and utilizes said appearance of said advertising information to deploy said advertising information within second advertising box;
(d) receives updated advertising information and updated appearance of said updated advertising information from said advertiser; and then
(e) delivers said updated advertising information and said updated appearance of said updated advertising information to an ad viewer computer and enables said ad viewer computer to display third advertising box and utilize said updated appearance of said updated advertising information to deploy said updated advertising information within said third advertising box.

14. The online advertising system of claim 13, further comprising an editing tool that is delivered to said advertiser computer with said first advertising box and said second advertising box, wherein said editing tool enables said advertiser to modify advertising information within said first advertising box and said second advertising box.

15. The online advertising system of claim 14, wherein said editing tool is executed independently of operating system platforms.

16. The online advertising system of claim 15, wherein said operating system platforms include a computer device (IBM-PC, Apple Macintosh, Tablet PC, etc.), a hand-held device (PDA, Palm, etc.), a phone device, or other devices running an HTML-capable viewer.

17. The online advertising system of claim 16, wherein said HTML-capable viewer includes Internet Explorer, Netscape and other web browsers, which are JavaScript-enabled.

18. The online advertising system of claim 17, wherein said editing tool is written in JavaScript.

19. The online advertising method of claim 14, wherein said modify includes changing advertising contents within said first advertising box and said second advertising box.

20. The online advertising method of claim 14, wherein said modify includes changing advertising objective within said first advertising box and said second advertising box.

21. The online advertising method of claim 14, wherein said modify includes changing localization of advertising contents within said first advertising box and said second advertising box.

22. The online advertising method of claim 14, wherein said modify includes identifying one or more templates that are associated with said first advertising box and said second advertising box.

23. The online advertising method of claim 13, wherein said advertising information include advertising objective, texts, pictures, movie clips, flash and html links.

24. The online advertising method of claim 14, wherein said advertising information include advertising objective, texts, pictures, movie clips, flash and html links.

25. The online advertising system of claim 13, further comprising a viewing process system that (a) receives a set of querying criterions from an ad viewer computer; (b) selects ads containing advertising information in accordance with said querying criterions; and then (c) delivers said ads to said ad viewer computer and renders said ad viewer computer to display said ads.

26. The online advertising system of claim 25, further comprising an ad viewer authorization system that (a) receives a request from an ad viewer; (b) retrieves a set of querying criterions associated with said ad viewer.

27. The online advertising system of claim 26, wherein said querying criterions are stored in a server where said authorization system is.

28. The online advertising system of claim 26, further comprising a RSS feed generating system that produces RSS feed in accordance with said querying criterions.

29. The online advertising system of claim 14, further comprising a viewing process system that (a) receives a set of querying criterions from an ad viewer computer; (b) selects ads containing advertising information in accordance with said querying criterions; and then (c) delivers said ads to said ad viewer computer and renders said ad viewer computer to display said ads.

30. The online advertising system of claim 29, further comprising an ad viewer authorization system that (a) receives a request from an ad viewer; (b) retrieves a set of querying criterions associated with said ad viewer.

31. The online advertising system of claim 30, wherein said querying criterions are stored in a server where said authorization system is.

32. The online advertising system of claim 30, further comprising a RSS feed generating system that produces RSS feed in accordance with said querying criterions.
